(19) United States
(12) Patent Application Publication
(10) Pub. No.: US 2006/0283307 A1
(43) Pub. Date: Dec. 21, 2006

(54) Saxophone key

(76) Inventor: Wei-Fu Lin, Fengyuan City (TW)

Correspondence Address: Troxell Law Office Pllc;Suite 1404, 5205 Leesburg Pike, Falls Church, VA, 22041, US

(21) Appl. No.: 11/156,727

(22) Filed: Jun. 21, 2005

(51) Int. Cl. G10D 7/08; G10D 9/04; G10D 9/00

(52) U.S. Cl. 84/385 R

(57) ABSTRACT

A saxophone key primarily consisting of a connected key fine-tuning structure for a saxophone, which is used to fine-tune the gaps between two connected keys of the saxophone, the fine-tuning structure is characterized in that: the fine-tuning structure consists of a tuning screw and a felt, wherein the tuning screw is fitted within a screw hole of a key surface of a connected key, moreover, the felt is affixed to a flat portion of one end of the tuning screw, the flat portion of the tuning screw being aligned with a tail end of a connecting rod of another connected key, lo and another end of the tuning screw is provided with an tuning groove. The fine-tuning structure can quickly and conveniently fine-tune the gap between the two connected keys. Moreover, the fine-tuning structure is able to reduce noise resulting from the keys colliding when being played.

### BACKGROUND OF THE INVENTION

(a) Field of the Invention

The present invention relates to a saxophone key, and more particularly to a fine-tuning structure installed between connected keys of a saxophone, that can quickly and conveniently fine-tune the gap between the two connected keys. Moreover, the fine-tuning structure is able to reduce noise resulting from the keys colliding when being played.

(b) Description of the Prior Art

When playing a base note on a conventional saxophone, for instance, by connecting a Low B key and a Low Bb key, if the aforementioned connected keys are unable to synchronize and a gap is produced when the saxophone is being played, then air will probably leak, thereby resulting in the note being unable to be played or the problem of the note not being a full base note, and a performing musician will thus be unable to achieve the required pitch. Such a shortcoming.generally requires the aid of a professional technician to adjust and restore the keys. Hence, many musical instrument companies are continually striving to overcome the aforementioned shortcoming, and thus several inventions have appeared disclosing improved tuning methods. A conventional tuning method relies on the technician to bend or straighten the keys so as to control connecting of the Low B key and the Low Bb key. However, shortcomings of such a method include the inability to achieve securing position at one time, which in fact requires adjusting many times, and reliance on the tuning skill of the professional technician to achieve a perfect tuned state. Referring to FIGS. 1, 2 and 3, which show an improved tuning structure, wherein a tuning piece b1 is configured on one side of a Low B key surface. Moreover, a center of the tuning piece b1 is provided with an oval groove b11. The tuning piece b1 connecting to a connecting rod d adds to a secure fixing of a tuning screw c between the connecting rod d and the tuning piece b1. The tuning screw c is used to adjust the distance between the Low B key b and the connecting rod d, and the gap between the Low B key b and the Low Bb key a is correspondingly adjusted. Although this improvement achieves a definite effect, however, when adjusting the tuning structure, it involves a one time alteration of two parts including the tuning screw c and the key surface, which must be carried out simultaneously to achieve the appropriate setting. Hence, the general user will not rashly attempt such a correction, and a technician is troubled to carry out the adjustment, which loses the original intention of fine-tuning. Moreover, adjustment range is restricted to within the oval groove, and, thus, other portions still rely on the method of bending the keys to reinforce the adjustment, which adds unnecessary manufacturing steps that are not only time-consuming and laborious, but also add to the tediousness of the adjusting procedure. Hence, the inventor of the present invention has invented a simplified fine-tuning structure that can quickly and conveniently fine-tune the gap between two connected keys. Moreover, the simplified fine-tuning structure is able to reduce noise resulting from the keys colliding when being played.

### SUMMARY OF THE INVENTION

In light of the shortcomings of the aforementioned conventional structure, the inventor of the present invention, having accumulated years of experience in related arts, attentively and circumspectly carried out extensive study and exploration to ultimately design a new improved saxophone key.

A primary objective of the present invention is to provide a connected key fine-tuning structure that can quickly and conveniently fine-tune the gap between the two connected keys. Moreover, the connected key fine-tuning structure is able to reduce noise resulting from the keys colliding When being played.

In order to achieve the aforementioned objective, the improved saxophone key of the present invention primarily consists of a fine-tuning structure, which comprises a tuning screw and a felt, wherein the tuning screw is fitted within a screw hole of a key surface of a connected key. Moreover, the felt is affixed to a flat portion of one end of the tuning screw, which is aligned with a tail end of a connecting rod of another connected key, and another end of the tuning screw is provided with a tuning groove.

According to the aforementioned structure, after connecting top and bottom portions using the tuning screw, the Low B key and the Low Bb key are easily closely fitted, thereby achieving effectiveness of synchronization when being played. Moreover, the structure only requires rotating the single tuning screw to complete all adjustments, which is not only able to quickly and conveniently accomplish fine-tuning, but is also able to easily achieve the equilibrium point. Hence, a general user can easily carry out the adjustment by himself. The present invention also simplifies the structure of the saxophone key, thereby having the further advantage of improved effectiveness that reduces maintenance costs for the general user. Furthermore, the felt provided on the flat portion of the tuning screw is used to reduce noise resulting from the metal keys colliding when being played. The same configuration can also be used for fine-tuning between other connected keys of the saxophone, for instance, the Low B key and the G♯ key, the Low C key and the G# key, and so on.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a schematic disposition view of connected keys in a conventional saxophone.

FIG. 1A is an enlarged view of the connected keys as illustrated in FIG. 1

FIG. 2 shows a structural elevational view of a conventional tuning structure.

FIG. 3 shows a front view of a conventional tuning structure.

FIG. 4 shows a structural elevational view of the present invention.

FIG. 5 shows a front view of the present invention.

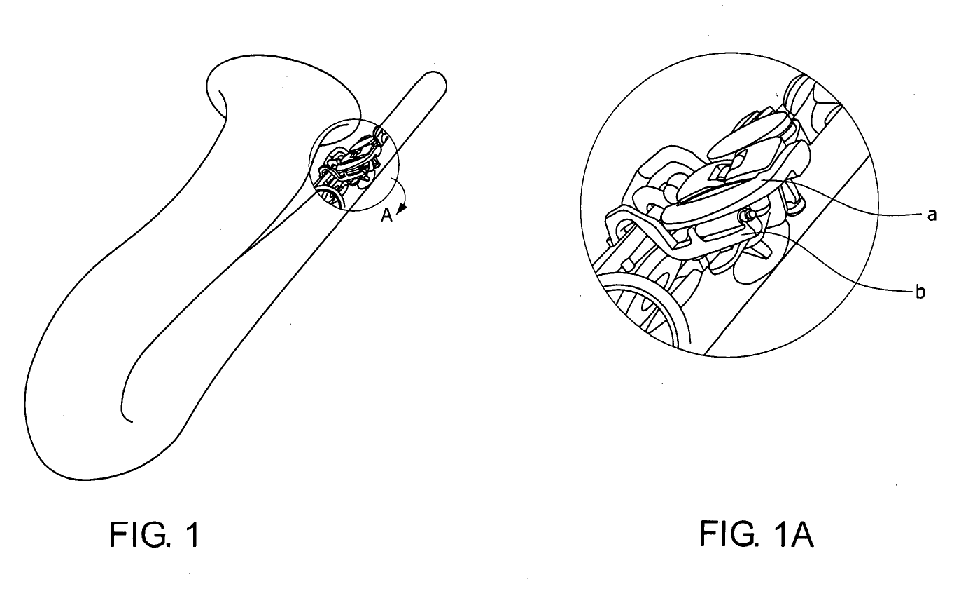

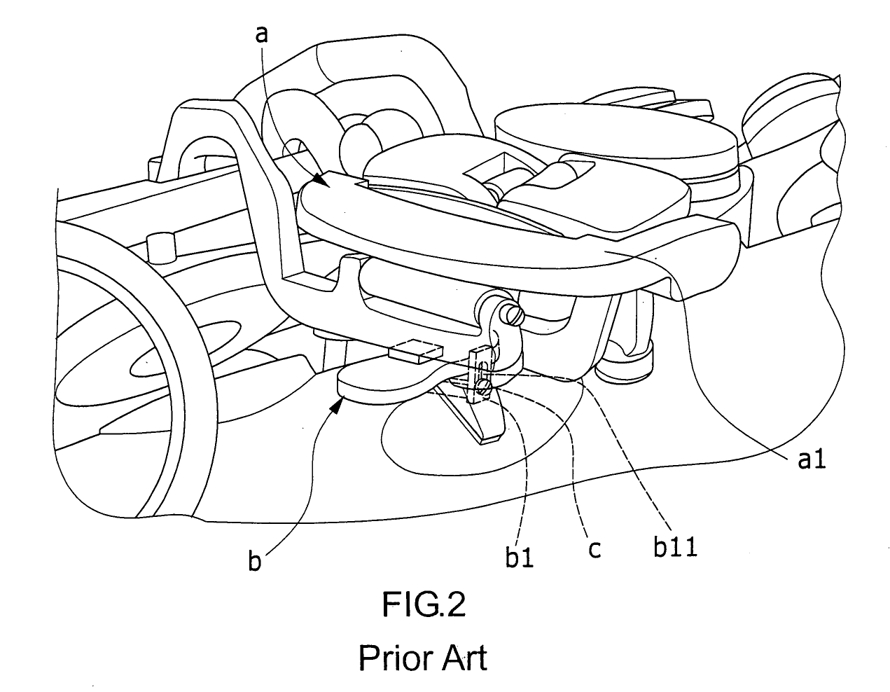

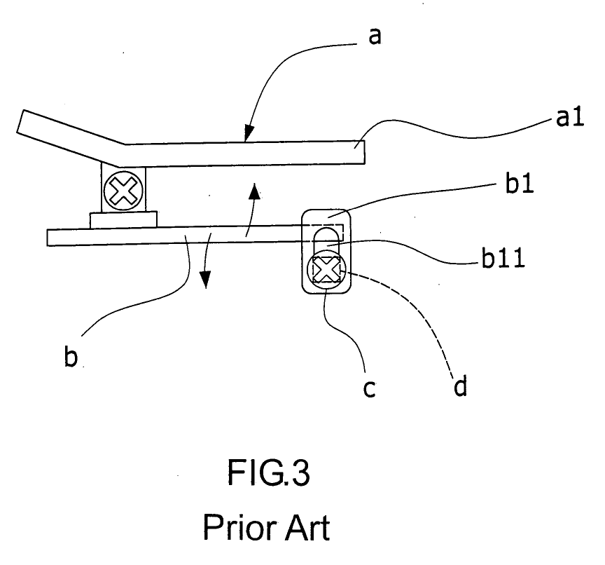

### DETAILED DESCRIPTION OF THE PREFERRED EMBODIMENTS

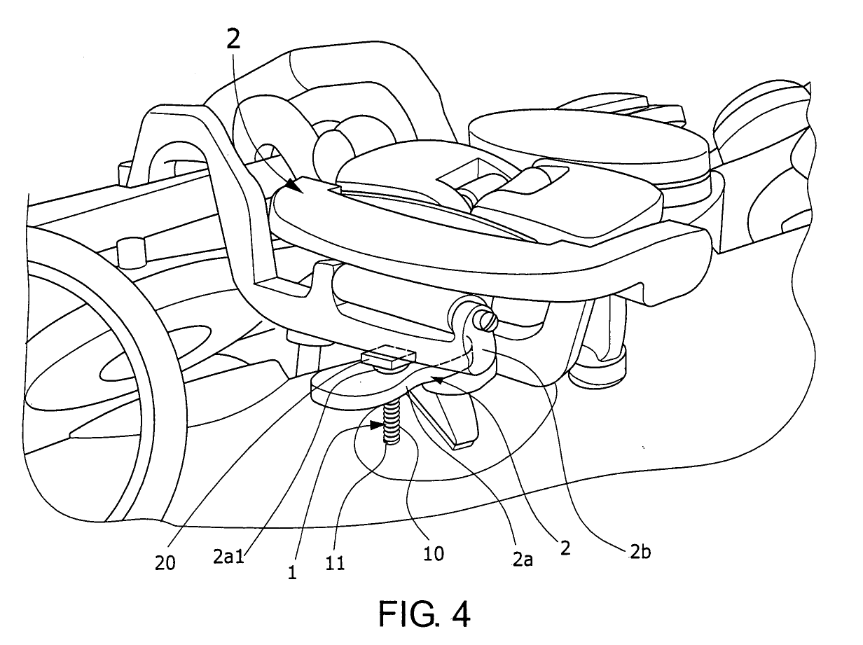

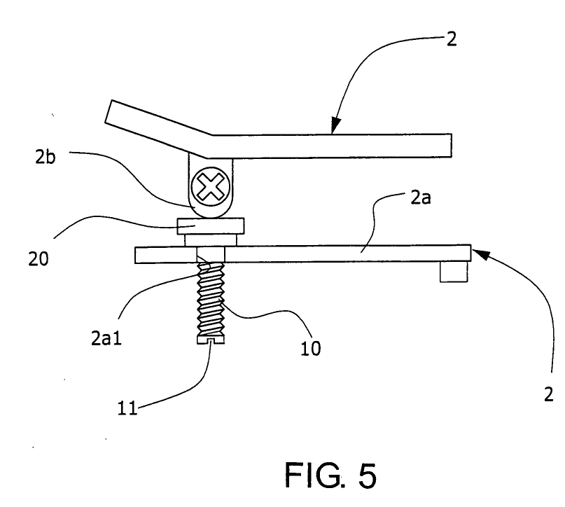

Referring to FIGS. 4 and 5, which show a connected key fine-tuning structure 1 of an improved saxophone key of the present invention, which can be installed in a treble saxophone, an alto saxophone, a tenor saxophone or an upper base saxophone.

The fine-tuning structure I comprises an tuning screw 10 and a felt 20, wherein the tuning screw 10 is fitted within a screw hole 2a1 pre-bored in a key surface 2a of a connected key 2. Moreover, the felt 20 is affixed to a flat portion of one end of the tuning screw 10, which is aligned with a tail end of a connecting rod 2b of another connected key 2, and another end of the tuning screw 10 is provided with a tuning groove 11. According to the aforementioned, the tuning screw 10 of the improved saxophone key of the present invention fitted within the screw hole 2a1 of the key surface 2a and the felt 20 affixed to the flat portion of the tuning screw 10 achieve an improved structure that can not only quickly and conveniently fine-tune the gap between the two connected keys 2. Furthermore, the structural improvement achieves effectiveness of reducing noise when the keys are being played, and is provided with advancement and practicability. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A saxophone key, comprising a connected key fine-tuning structure for a saxophone, which is used to fine-tune the gap between two connected keys of the saxophone, for instance, the Low B key, the Low Bb key, the Low C key and the G♯ key, and so on, and characterized in that: the fine-tuning structure comprises an tuning screw and a felt, wherein the tuning screw is fitted within a screw hole of a key surface of a connected key, moreover, the felt is affixed to a flat portion of one end of the tuning screw, the flat portion of the tuning screw being aligned with a tail end of a connecting rod of another connected key, and another end of the tuning screw is provided with an tuning groove.

2. The saxophone key. according to claim 1, wherein the fine-tuning structure is installed in a treble saxophone.

3. The saxophone key according to claim 1, wherein the fine-tuning structure is installed in an alto saxophone.

4. The saxophone key according to claim 1, wherein the fine-tuning structure is installed in a tenor saxophone.

5. The saxophone key according to claim 1, wherein the fine-tuning structure is installed in an upper base saxophone.
